(19) United States
(12) Patent Application Publication
(10) Pub. No.: US 2009/0178583 A1
(43) Pub. Date: Jul. 16, 2009

(54) PAD PRINTING SYSTEM WITH INDEPENDENT AND VARIABLE COMPRESSION DEVICE

(76) Inventors: Anatoly Gosis, Palatine, IL (US); Tracy Kucaba, South Elgin, IL (US); Frank Otte, Mount Prospect, IL (US); Christopher Schaafsma, Wheaton, IL (US)

Correspondence Address: CARDINAL LAW GROUP, 1603 Orrington Avenue, Suite 2000, Evanston, IL, 60201, US

(21) Appl. No.: 12/372,550

(22) Filed: Feb. 17, 2009

Related U.S. Application Data
(63) Continuation-in-part of application No. 11/927,404, filed on Oct. 29, 2007.
(60) Provisional application No. 60/867,997, filed on Nov. 30, 2006.

(51) Int. Cl. B41F 1/00

(52) U.S. Cl. 101/163

(57) ABSTRACT

A pad printing system includes a doctor assembly comprising a cliché, an ink cup, and a variable hold down force system configured to apply a variable force to the ink cup and doctor assembly responsive to a direction of travel.

### RELATED APPLICATIONS

This application claims the benefit of, and priority to, U.S. patent application Ser. No. 11/927,404 filed Oct. 29, 2007 as a continuation in part application. Application Ser. No. 11/927,404 claims priority to U.S. Provisional Patent Application 60/867,997 filed Nov. 30, 2006, the entirety of which is hereby incorporated by reference.

### TECHNICAL FIELD OF THE INVENTION

The present invention relates generally to printing and in particular to pad printing.

### BACKGROUND OF THE INVENTION

Pad printing has been used for many years to apply an image to a product. Pad printing is especially prevalent in applications for applying images to rounded products, such as syringes and golf balls.

Efficient ink transfer is important to final image quality in a pad printing system. A doctor assembly includes an ink cup having a rigidly attached annular wiping element known as a doctor. An image bearing cliché device cycles its position to place the image under a resilient printing pad, the doctor then scrapes the excess ink guided by the un-patterned surface of the cliché device. The cliché device surface is not flat, but is within tolerances for the pad printing system. The same is true for the doctor annular surface. As a result of these irregularities in the surfaces, the two surfaces do not create a 100% contact match, thus allowing some ink to escape through the areas of mismatch. Prolonged lapping of the respective surfaces causes both surfaces to wear thereby reducing the initial surface mismatch when the surfaces are static.

A compression device is used to maintain contact between the doctor assembly and the cliché device. The compression device maintains this contact by the application of force on the doctor assembly. The contact must be sufficient to prevent ink from escaping between the doctor assembly and the cliché device. Excessive contact pressure results in premature wear of the cliché device and the doctor. The compression device provides contact pressure while the cliché device or the doctor assembly is stationary or while either component is in motion.

FIG. 1a illustrates a top view of one example of a pad printing system in accordance with the prior art at 100.

The pad printing system 105 includes a cliché device 110 and a doctor assembly 112. The doctor assembly includes an ink cup 120 having a rim 122. Doctor assembly 112 is located in contact with cliché device 110. Two axially opposed contact points 140a and 140b are shown on rim 122, located in the equatorial plane of ink cup 120. Contact pressure between doctor assembly 112 and cliché device 110 is provided by a force applicator 142 that includes a pair of force transfer units 142a and 142b contacting rim 122 at axially opposed contact points 140a and 140b. In one example, doctor assembly 112 is fixed to support 144 and cliché device 110 is translated laterally in contact with doctor assembly. In another embodiment, cliché device 110 is fixed and doctor assembly 112 is translated across cliché device 110.

FIG. 1b illustrates a side view of one example of a pad printing system, in accordance with the prior art at 101.

An annular doctor blade 130 is affixed to rim 122 of doctor assembly 112. Annular doctor blade 130 provides a seal between doctor assembly 112 and cliché device 110 that limits the quantity of ink that can leak from ink cup 120. In addition, the annular doctor blade wipes excess ink from cliché device 110 as the doctor assembly and the cliché device move relative to each other. Force applicator 142a engages rim 122 at contact point 140a.

FIG. 2 illustrates one example of a pad printing system in operation, in accordance with the prior art at 200. When the pad printing system 105 begins a print cycle, cliché device 110 starts a lateral translation with respect to the doctor assembly 112. As the cliché device moves, in contact with the doctor blade, static friction is converted to dynamic friction, inducing the ink cup to pivot around a line through contact point 142a and perpendicular to the direction of motion. The dynamic friction pivots a leading edge 150 of ink cup 120 down against clichédevice 110 and consequently allows a trailing edge 152 to pivot away from cliché device 110. The portion of the doctor assembly that first traverses an image portion 260 of the cliché device is termed the leading edge. This pivoting motion results in a periodic separation of cliché device 110 and doctor blade 130 adjacent the trailing edge of doctor assembly 112.

The periodic separation of doctor assembly 112 and cliché device 110 allows ink to leak from ink-cup 120 as the cliché device moves relative to the doctor assembly. The quantity of ink that leaks is dependent on various process parameters such as acceleration, deceleration, and velocity of the cliché device or the doctor assembly. The ink that has leaked needs to be periodically cleaned from the system. Additionally, the separation of the cliché and the doctor assembly allows possible contamination of the ink by foreign material. Furthermore, the increase in contact force at leading edge 150, by doctor blade 130, contributes to premature wear of cliché device 110.

It is, therefore, desirable to provide a system for pad printing that would overcome the aforementioned and other disadvantages.

### SUMMARY OF THE INVENTION

One aspect of the invention provides a pad printing system that includes a doctor assembly with a rim. The rim includes a first contact point, second contact point, third contact point, and fourth contact point. The first contact point is offset a fixed distance from the second contact point, the second contact point is offset the fixed distance from the third contact point, the third contact point is offset the fixed distance from the fourth contact point, and the fourth contact point is offset from the first contact point by the fixed distance. The assembly further includes a first force applicator applying force at the first contact point and third contact point and a second force applicator applying force at the second contact point and fourth contact point

Another aspect of the invention provides a doctor assembly that includes a cliché including an ink cup surface and an ink cup configured to mate with the ink cup surface on a first side. The assembly further includes at least a first clamp member and a second clamp member, each of the first clamp member and second clamp member including a pivot point shaft positioned opposite the first side, wherein the first clamp member and second clamp member clamp the ink cup to the cliché such that the ink cup contacts the cliché at the ink cup surface.

A third aspect of the invention provides a doctor assembly comprising a cliché and an ink cup. The assembly further includes a variable hold down force system configured to apply a variable force to the ink cup and doctor assembly responsive to a direction of travel.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1a illustrates a top view of one example of a pad printing system in accordance with the prior art;

FIG. 1b illustrates a side view of one example of a pad printing system, in accordance with the prior art;

FIG. 2 illustrates one example of a pad printing system in operation, in accordance with the prior art;

FIG. 3A illustrates a schematic representative of a top view of one example of a pad printing system with a compression device, in accordance with the invention;

FIG. 3B illustrates an alternate embodiment of a compression device, in accordance with the invention;

FIG. 4 illustrates a schematic representative of a side view of one example of a pad printing system with a compression device, in accordance with the invention;

FIG. 5a through FIG. 5b illustrates schematics representative of one example of a pad printing system with compression device in operation, in accordance with the invention;

FIG. 6 illustrates a flowchart of one example of a method for pad printing with compression device, in accordance with the invention;

FIG. 7a through FIG. 7b illustrates schematics representative of one example of a force applicator, in accordance with the invention; and

FIGS. 8A, 8B, and 9 illustrate one embodiment of a pad printing system in accordance with another aspect of the invention.

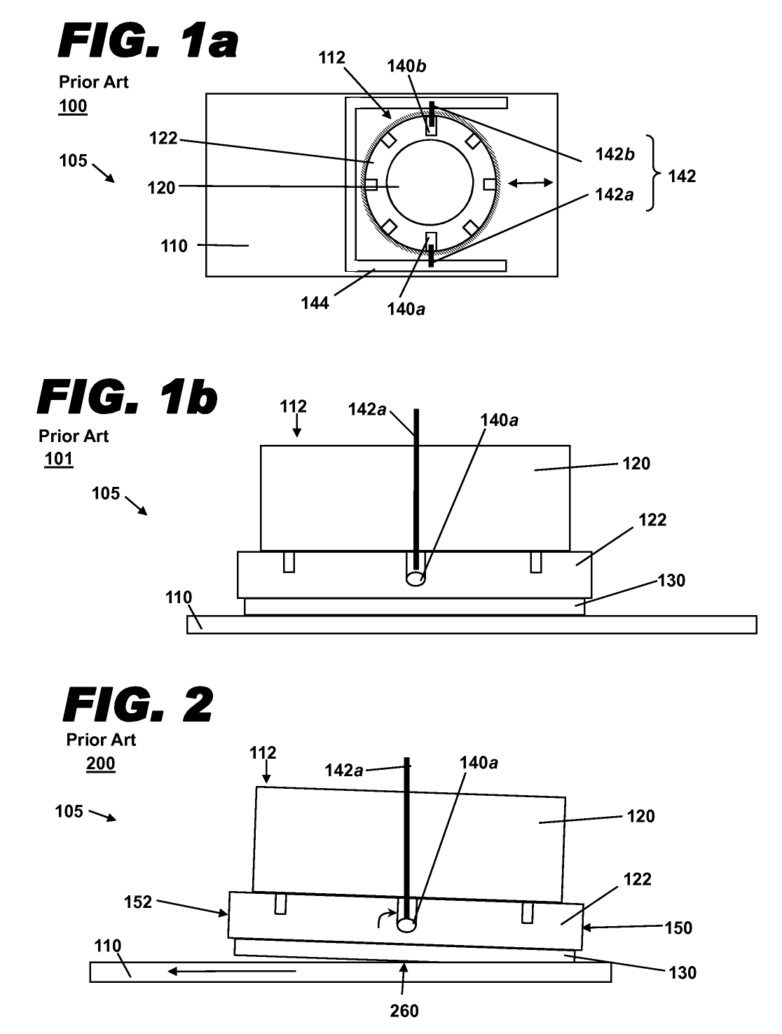

### DETAILED DESCRIPTION OF THE PRESENTLY PREFERRED EMBODIMENTS

The invention provides for the independent application of forces along an ink cup to counter a torque applied by virtue of friction forces. In addition, the independent application of force reduces wear and tear on cliché devices. Further, the ink cup can float over inconsistent surfaces of either the cliché device or doctor. In addition, active adjustment of the hold down force applied to a front of the ink cup and a back of the ink cup allows for improved countering of the friction pivot and improved doctoring of the cliché device with reduced hold down forces.

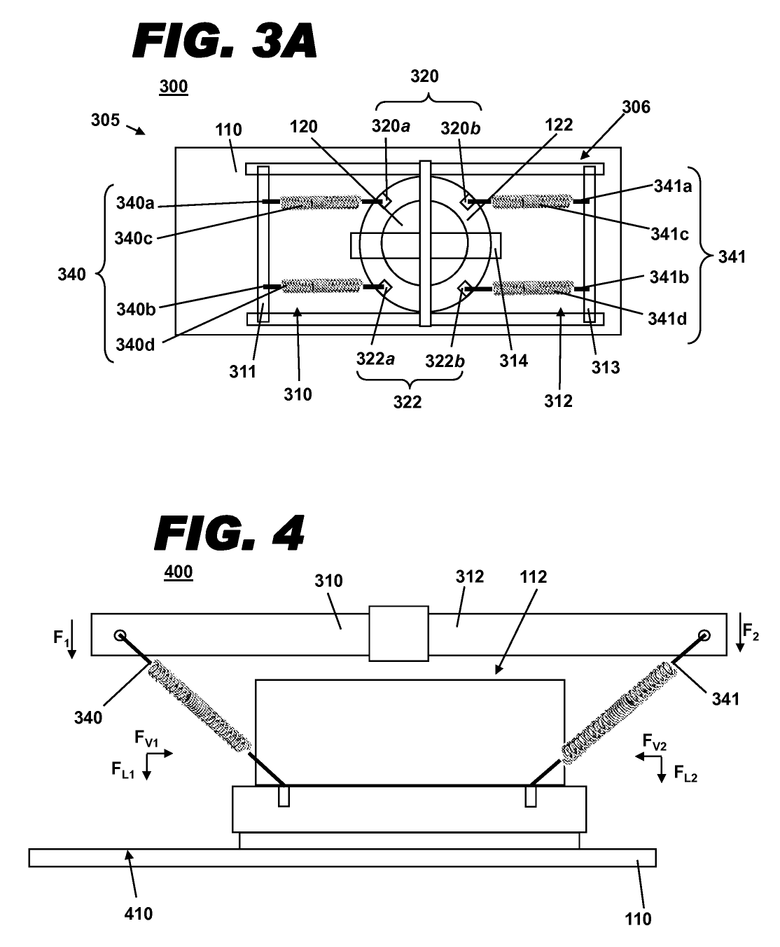

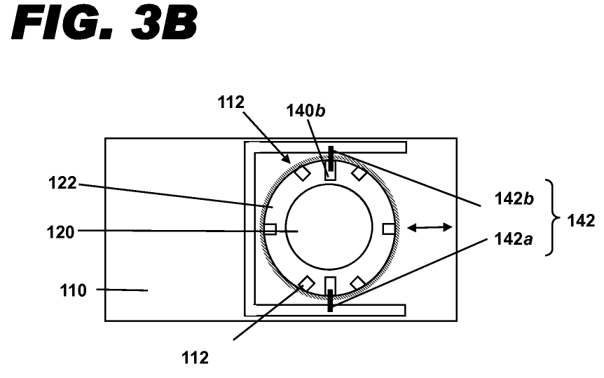

FIG. 3A illustrates a schematic representative of a top view of one example of a pad printing system with a variable compression device, in accordance with the invention at 300.

The pad printing system 305 includes doctor assembly 112, a compression device 306, and a cliché device 110. The doctor assembly includes ink-cup 120 having rim 122. The doctor assembly also includes a first set 320 of contact points 320a, 320b and a second set 322 of contact points 322a, 322b at which a hold down force F₁ is applied to the doctor assembly by the compression device.

Each set of contact points 320 and 322 includes at least two contact points located at approximately opposite coplanar positions on rim 122 of ink cup 120. In one embodiment, the contact points are positioned as far apart as possible to increase uniform contact between doctor assembly 112 and cliché 110. In one example, doctor assembly 112 includes more than two sets of contact points. In another example, the doctor assembly includes one set of contact points, the set having at least three contact points. In a further example, the contact points are non-coplanar.

In other words, in one embodiment, the doctor assembly includes a rim including a first contact point 320a, second contact point 320b third contact point 322a, and fourth contact point 322b. The first contact point 320a is offset a fixed distance from the second contact point 320b, the second contact point 320b is offset the fixed distance from the third contact point 322a, the third contact point 322a is offset the fixed distance from the fourth contact point 322b, and the fourth contact point 322b is offset from the first contact point 320a by the fixed distance.

Compression device 306 includes a first force applicator 310, and a second force applicator 312. A cup stop 314 is located adjacent doctor assembly 112. Cup stop 314 limits lateral motion of the doctor assembly.

Hold down force F₁ is supplied at each set of contact points through force applicators 310, 312. In one example, force applicators 310, 312 are connected in a single force applicator unit. Each force applicator 310, 312 includes a set of force transfer units 340, 341. The hold down force F₁ is transferred from force applicators 310, 312 to doctor assembly 112 through sets of force transfer units 340, 341. Each set includes two force transfer units 340a, 340b and 341a, 341b. The force transfer units each include a spring device 340c, 340d and 341c, 341d for applying a variable degree of force at each contact point in contact point sets 320, 322 on rim 122 of doctor assembly 112. In one example, the force transfer units are included as an attachment to a push rod (not shown).

Each force transfer unit in sets 340, 341 is pivotally attached at one end to doctor assembly 112 and at a second end, linearly displaced from the first, to a cross-bar 311, 313. In one example, the force transfer units in sets 340, 341 are fixedly attached at one end to doctor assembly 112 and at a second end, linearly displaced from the first end, to cross-bar 311, 313. In another example, a combination of fixed and pivoting attachments is used.

FIG. 3B illustrates a similar embodiment as in FIG. 3A, but in FIG. 3B, the contact points are symmetrically positioned, but not equidistantly from each other. Specifically, the first and third contact points are positioned symmetrically about a plane substantially perpendicular with a direction of motion of the doctor assembly and the second and fourth contact point are positioned symmetrically about the plane. Additionally, each of the first and third contact points are substantially centered along an axis of travel substantially equidistant from a centerline of the doctor assembly and the second and fourth contact points are similarly substantially equidistant from the centerline, but on an opposing side of the centerline.

FIG. 4 illustrates a schematic representative of a side view of one example of a pad printing system with compression device, in accordance with the invention at 400.

Both sets of force transfer units 340 and 341 extend, respectively, from cross-bar 311, 313 to doctor assembly 112 at a non-zero angle relative to a center axis of the doctor assembly. Force applicators 310, 312 apply forces F₁ and F₂, respectively, in a direction parallel to the center axis of the doctor assembly. The angled orientation of the force transfer units translates the hold down forces F₁ and F₂ into vertical force components F_{V1} and F_{V2} and lateral force components F_{L1} and F_{L2}.

When there is no movement of the system the vertical force components are static and approximately equal at each force transfer unit. The vertical force components maintain contact between cliché device 110 and doctor assembly 112 adjacent an image portion 260 of the cliché device.

The lateral force components, which would tend to displace doctor assembly 112, are also static. Lateral force component F_{L1} is balanced by an equal and opposite lateral force component F_{L2}. In one embodiment, wherein three force transfer units are used, one force transfer unit is designed to provide vertical and lateral and forces to balance those forces supplied by two other opposing force transfer units. Each force transfer unit engages the respective contact point at a point or small arc in an attempt to minimize the magnitude of lateral forces on the doctor assembly.

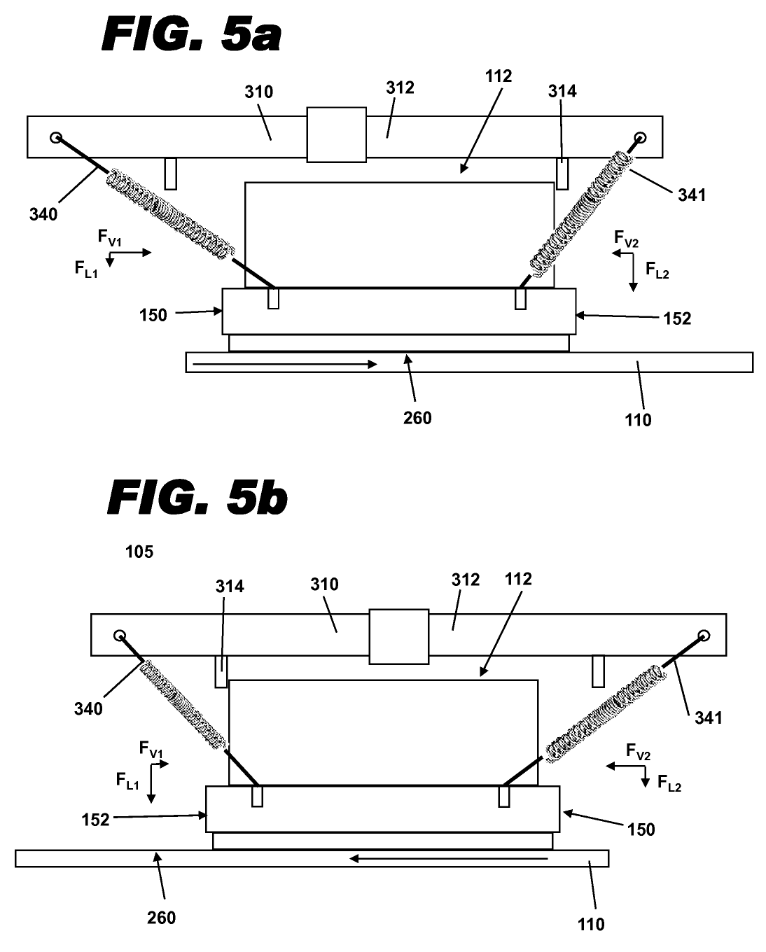

FIG. 5a through FIG. 5b illustrates schematics representative of one example of a pad printing system with compression device in operation, in accordance with the invention at 500.

As cliché device 110 is translated relative to doctor assembly 112, as illustrated in FIG. 5a, dynamic frictional forces are generated that are greatest at the leading edge 150 of doctor assembly 112. The dynamic frictional forces generated by translation of the cliché device tend to bias pivot leading edge 150 down against the cliché device. To compensate for the effect of this dynamic frictional force, the doctor assembly slides against cup stop 314 adjacent trailing edge 152 of doctor assembly 112. As doctor assembly 112 slides against cup stop 314, the spring devices in the set of force transfer units 340 adjacent leading edge 150 extend, thereby reducing the hold down force at the leading edge. The extension of the spring devices functions to lift the leading edge away from cliché device 110, thereby compensating for the increased frictional force and the tendency for the leading edge to pivot down against the cliché device.

Additionally, each spring device in the set of force transfer units 341 adjacent trailing edge 152 of doctor assembly 112 compresses as the doctor assembly slides against cup stop 314, thereby increasing the hold down force at the trailing edge. The compression of the spring devices functions to push the trailing edge down against cliché device 110, thereby compensating for the tendency for the trailing edge to pivot away from the cliché device.

As cliché device 110 is translated relative to doctor assembly 112, in the opposite direction, as illustrated in FIG. 5b, the trailing edge and the leading edge are reversed. The operation of the compression device is a function of the direction of travel. The action of the spring device of the force transfer units is therefore analogous to that in the previous example.

In one example, the doctor assembly is translated relative to the cliché device. The operation of compression device 306 corresponds to the example where the cliché device is translated relative to the doctor assembly. The leading edge of the doctor assembly, in either example, is the portion of the doctor assembly that first traverses image portion 260 of the cliché device.

Replacing one or more of the spring devices in force applicator 310, 312 with a spring device having a different spring tension allows the system to be tuned in an attempt to provide the most effective force balance. In one example the spring device has an adjustable spring tension.

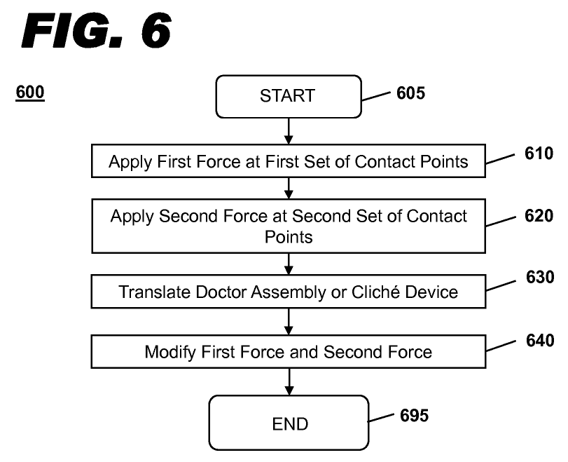

FIG. 6 illustrates a flowchart of one example of a method for pad printing with compression device, in accordance with the invention at 600. The method begins (block 605).

A first force is supplied to a first set of contact points (block 610) and a second force is supplied to a second set of contact points (block 620). The first set of contact points is offset from the second set of contact points. The first force and the second force are supplied by a compression device. The contact points are located on the doctor assembly of the pad printing system. The first and second forces keep the doctor assembly in contact with an image bearing cliché device.

The doctor assembly or the cliché device is translated one relative to the other (block 630). The translation includes moving the image portion of the cliché device back and forth beneath the doctor assembly where ink is deposited on the image portion of the cliché device and then excess ink is removed.

The first force and the second forces are modified (block 640) independently to maintain uniform contact between the doctor assembly and the cliché device as the doctor assembly and the cliché device are translated relative to each other. The uniform contact helps prevent ink from leaking from between the doctor assembly and the cliché device.

The method terminates at block 695.

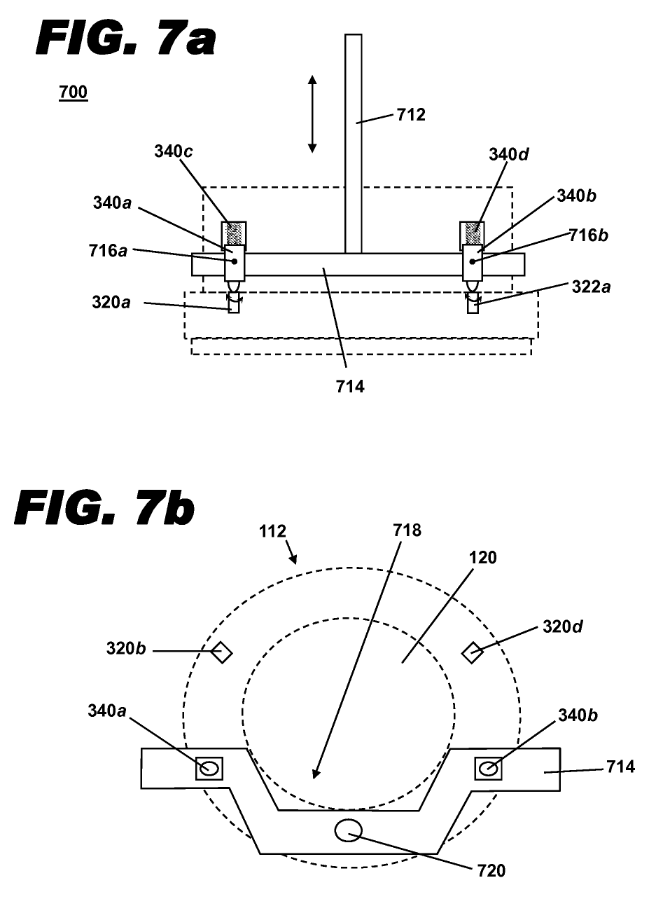

FIG. 7a and FIG. 7b illustrate schematics representative of one example of a force applicator, in accordance with the invention at 700.

In another embodiment, a force applicator is illustrated in FIG. 7a. As shown in FIG. 7a, the force applicator includes a stem 712 and a cross-bar 714 in a “T” configuration. Adjacent either end of cross-bar 714 is force transfer units 340a and 340b including spring devices 340c and 340d. In one example, the force transfer units are capable of pivoting about a pivot point 716a and 716b. In one example, the force transfer units are non-pivoting. The force applicator is raised and lowered with stem 712 to engage contact points 320a and 322a. Second force applicator (not shown) engages contact points 320b and 322b shown in FIG. 7b.

FIG. 7b illustrates a top view of the cross-bar 714 of the force applicator. The cross-bar 714 is non-linear including a deviation 718 that allows the cross-bar to circumvent the ink cup 120 of the doctor assembly 112. The stem is fixed to the cross-bar at a connection point 720 located in the approximate center of the cross-bar's length.

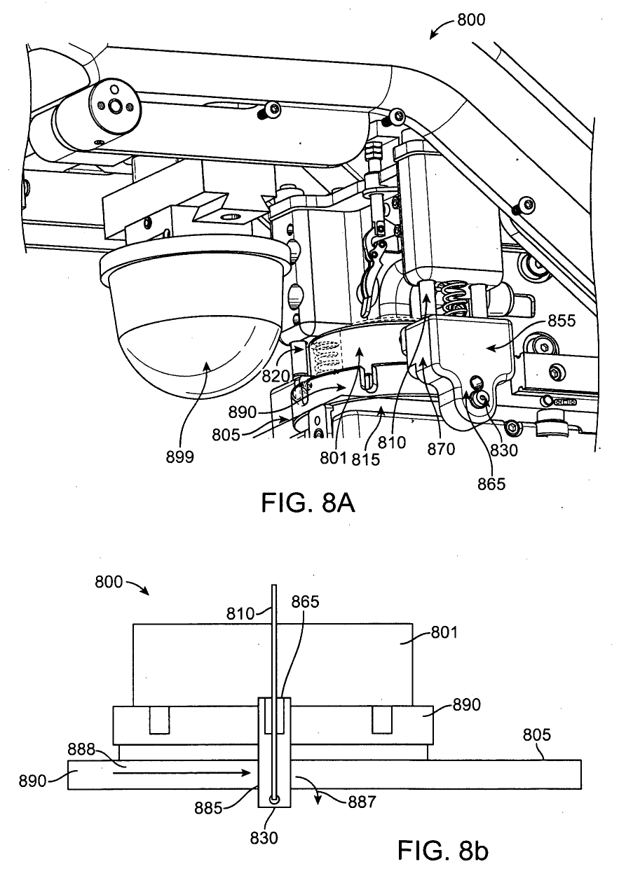

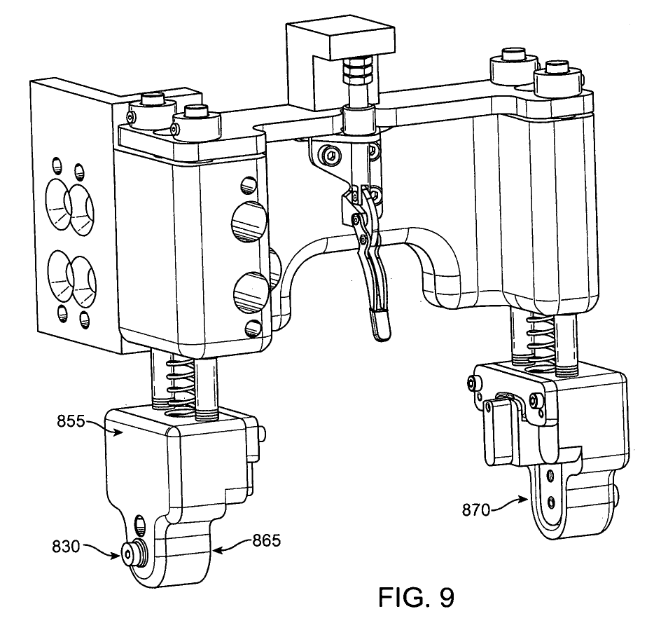

FIGS. 8A, 8B, and 9 illustrate a portion of a doctor assembly 800, in accordance with another aspect of the invention. FIG. 8A is a perspective view of the assembly including the ink cup and cliché, and FIG. 8B is a side view of the assembly, whereas FIG. 9 is a perspective view of the first and second clamp members, with a floating member. Like numbers indicate like structures in each of FIGS. 8A, 8B, and 9. Doctor assembly 800 includes an ink cup 801 and a cliché 890 including an ink cup surface 805 and an opposing surface 815 offset from the ink cup surface. The ink cup contacts the ink cup surface 805 on a first side. Additionally, doctor assembly 800 further includes at least a first clamp member 810 and a second clamp member 820. Each of the first clamp member 810 and second clamp member 820 include a pivot point shaft 830 positioned on a side of the cliché opposite first side, or opposite the ink cup surface 805. The first clamp member and second clamp member clamp the ink cup 801 to the cliché 890 such that the ink cup 801 contacts the cliché 890 at the ink cup surface 805.

In one embodiment, the first clamp member 810 and second clamp member 820 cooperate to restrict rotation of the ink cup 801 relative to the first clamp member 810 and second clamp member 820. The clamping member allows the ink cup and the cliché to rotate with each other. In another embodiment, a friction force 888 resulting from lateral movement of the cliché 890 and ink cup 801 assembly generates a torque 887 about the pivot point shaft 830 such that the torque reduces the vertical force applied at the leading edge of the ink cup, and wherein the torque increases the vertical force applied by the trailing edge of the ink cup.

In one embodiment, at least one of the first clamp member 810 and second clamp member 820 includes an upper portion 855 and lower portion 865, and wherein the lower portion 855 is fixedly attached to a floating member 870 such that the floating member 870 is not connected to the upper portion 855, and wherein the floating member 870 transfers forces from the clamp member 810, 820 to the ink cup surface 805. This is best seen in FIG. 9.

In other embodiments, the system further includes an ink pad 899 for applying ink from the cliché to the item to be pad printed.

In one embodiment, rather than use springs or other mechanical forces, the invention is implemented with pneumatic devices with variable hold down forces. The invention describes a variable hold down force system configured to apply a variable force to the ink cup and doctor assembly responsive to a direction of travel. Other techniques to obtain this variable hold down force include numerically controlled devices activating air or pneumatic devices, use of air springs, numerically controlled force applicators that automatically increase or lessen applied force responsive to travel, and other techniques.

It is important to note that the figures and description illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A pad printing system, comprising:
a doctor assembly including a rim, the rim including a first contact point, second contact point, third contact point, and fourth contact point, wherein the first contact point is offset a fixed distance from the second contact point, the second contact point is offset the fixed distance from the third contact point, the third contact point is offset the fixed distance from the fourth contact point, and the fourth contact point is offset from the first contact point by the fixed distance;
a first force applicator applying force at the first contact point and third contact point; and
a second force applicator applying force at the second contact point and fourth contact point.

2. The system of claim 1, further comprising a cup stop, wherein the cup stop partially limits a lateral motion of the doctor assembly.

3. The system of claim 1, wherein the doctor assembly is operably attached to an ink cup having an annular doctor blade and wherein the forces applied by the first force applicator and second force applicator maintain contact between the ink cup and the doctor assembly.

4. The system of claim 1, wherein at least one of the first force applicator and second force applicator comprises:
at least one force transfer unit; and
at least one spring device operably connected to the force transfer unit.

5. The system of claim 4, wherein the force transfer unit includes a rod.

6. The system of claim 4, wherein at least one of the first force applicator and second force applicator engages the doctor assembly at one of the contact points through the force transfer unit.

7. The system of claim 1 wherein at least one of the first force applicator and second force applicator further comprises a cross-bar, wherein the cross-bar transmits applied force to a force transfer unit.

8. A doctor assembly comprising:
a cliché including an ink cup surface;
an ink cup configured to mate with the ink cup surface on a first side; and
at least a first clamp member and a second clamp member, each of the first clamp member and second clamp member including a pivot point shaft positioned opposite the first side, wherein the first clamp member and second clamp member clamp the ink cup to the cliché such that the ink cup contacts the cliché at the ink cup surface.

9. The assembly of claim 8 wherein the first clamp member and second clamp member cooperate to restrict rotation of the ink cup relative to the first clamp member and second clamp member, and wherein the pivot point shaft allows rotation of the ink cup and clamp member relative to the cliché.

10. The assembly of claim 8 wherein a friction force resulting from lateral movement of the cliché and ink cup assembly generates a torque about the pivot point shaft such that the torque reduces the force applied by the leading one of the first clamp member and second clamp member, and wherein the torque increases the force applied by the trailing one of the first clamp member and second clamp member.

11. The assembly of claim 8 wherein at least one of the first clamp member and second clamp member includes an upper portion and lower portion, and wherein the lower portion is fixedly attached to a floating member such that the floating member is not connected to the upper portion, and wherein the floating member transfers forces from the clamp member to the ink cup surface.

12. A pad printing system, comprising:
a doctor assembly comprising a cliché;
an ink cup; and
a variable hold down force system configured to apply a variable force to the ink cup and doctor assembly responsive to a direction of travel.

13. The system of claim 12 wherein the doctor assembly includes a rim, the rim including a first contact point, second contact point, third contact point, and fourth contact point, wherein the first and third contact point are positioned symmetrically about a plane substantially perpendicular with a direction of motion of the doctor assembly, and wherein each of the first and third contact point are substantially centered along an axis of travel substantially equidistant from a centerline of the doctor assembly;
a first force applicator applying force at the first contact point and third contact point; and
a second force applicator applying force at the second contact point and fourth contact point.

14. The system of claim 13 wherein the second contact point and fourth contact point are substantially centered along an axis of travel substantially equidistant from a centerline of the doctor assembly.

15. The system of claim 12 wherein the doctor assembly includes a rim, the rim including a first contact point, second contact point, third contact point, and fourth contact point, wherein the first contact point is offset a fixed distance from the second contact point, the second contact point is offset the fixed distance from the third contact point, the third contact point is offset the fixed distance from the fourth contact point, and the fourth contact point is offset from the first contact point by the fixed distance.

16. The system of claim 12 wherein the doctor assembly includes a cliché including an ink cup surface, an ink cup configured to mate with the ink cup surface on a first side, and at least a first clamp member and a second clamp member, each of the first clamp member and second clamp member including a pivot point shaft positioned opposite the first side, wherein the first clamp member and second clamp member clamp the ink cup to the cliché such that the ink cup contacts the cliché at the ink cup surface.
